(19) United States
(12) Patent Application Publication
(10) Pub. No.: US 2007/0294381 A1
(43) Pub. Date: Dec. 20, 2007

(54) Method of controlling services between network services, network device capable of performing the method, and storage medium that stores the method

(75) Inventors: Jin-woo Hong, Suwon-si (KR); Dae-gyu Bae, Suwon-si (KR); Se-hoon Moon, Seongnam-si (KR); Hyun-ah Sung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/645,775

(22) Filed: Dec. 27, 2006

(30) Foreign Application Priority Data
Jun. 15, 2006 (KR) 10-2006-0053893

(51) Int. Cl. G06F 15/173

(52) U.S. Cl. 709/223

(57) ABSTRACT

A method of controlling services that can be used between network devices using only one network device, the network device that performs the method, and a storage medium that stores the method are provided. The method includes the operations of producing integrated service information from service information of a network device and service information of a partner network device that is connected with the network device, and outputting the integrated service information to the network device. Accordingly, controlling a service that can be used between network devices is facilitated.

### CROSS-REFERENCE TO RELATED PATENT APPLICATION

This application claims priority from Korean Patent Application No. 10-2006-0053893, filed on Jun. 15, 2006, in the Korean Intellectual Property Office, the disclosure of which is incorporated herein in by reference in its entirety.

### BACKGROUND OF THE INVENTION

1. Field of the Invention

Methods and apparatuses consistent with the present invention relate to control of services that can be used between networked devices, and more particularly, to a method of controlling services that can be used between networked devices, a networked device capable of performing the method, and a storage medium that stores a program which performs the method.

2. Description of the Related Art

Examples of network devices include camcorders, compact disc (CDs) players, digital versatile disc (DVD) players, audio players, digital televisions (DTVs), and consumer electronic (CE) devices, like home theaters.

To control a service that can be used between these network devices a user should control the service using each of the network devices.

For example, when using a service based on both a file reproducing service of a camcorder and a main screen reproducing service of a DTV, a user should control the file reproducing service using the camcorder and the main screen reproducing service using the DTV. That is, the user should control the file reproducing service using a controller of the camcorder and the main screen reproducing service using a controller of the DTV. As such, when controlling services that can be used between network devices, the network devices should control their respective control services.

### SUMMARY OF THE INVENTION

The present invention provides a method of controlling services that can be used between network devices, using a single network device, the network device that performs the method, and a storage medium that stores the method.

According to an aspect of the present invention, there is provided a method of controlling services that can be used between network devices, the method including the operations of producing integrated service information from service information of a network device and service information of a partner network device that is connected with the network device, and outputting the integrated service information to the network device.

The method may further include an operation of controlling a service of the network device and a service of the partner network device based on the integrated service information.

The method may further include transmitting the service information of the network device to the partner network device when the partner network device requests the service information from the network device.

According to another aspect of the present invention, there is provided a network device including: a reception module which receives service information from a partner network device which is connected to the network device; a storage module which stores service information of the network device; an integrated service information production module which produces integrated service information from the service information of the partner network device and the service information of the network device; and a user interface module which outputs the integrated service information.

The network device may further include: a control module which controls a service of the network device and simultaneously produces a service request signal for requesting the partner network device for a service, in response to a signal which controls the services of the network device and the services of the partner network device based on the integrated service information output by the user interface module; and a transmission module which transmits the service request signal produced by the control module to the partner network device.

According to another aspect of the present invention, there is provided a computer-readable storage medium that stores a program which performs a method of controlling services connected between network devices, the method comprising: producing integrated service information for service information of a network device with service information of a partner network device that is connected with the network device; and outputting the integrated service information to the network device.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a network device according to an exemplary embodiment of the present invention;

FIG. 2 illustrates an example of service information that a network device receives from a partner network device which is connected with the network device;

FIG. 3 illustrates an example of service information of a network device;

FIG. 4 illustrates an example of integrated service information produced according to the present invention;

FIG. 5 illustrates another example of integrated service information produced according to the present invention;

FIG. 6 illustrates still another example of integrated service information produced according to the present invention;

FIG. 7 illustrates an example of integrated service information output by each network device according to the present invention;

FIG. 8 is a block diagram of a network device according to another exemplary embodiment of the present invention;

FIG. 9 is a flowchart illustrating a method of controlling a service between network devices, according to another exemplary embodiment of the present invention;

FIG. 10 is a flowchart illustrating an integrated service information producing operation illustrated in FIG. 9; and

FIG. 11 is a flowchart illustrating a method of controlling a service between network devices, according to another exemplary embodiment of the present invention.

### DETAILED DESCRIPTION OF EXEMPLARY EMBODIMENTS OF THE INVENTION

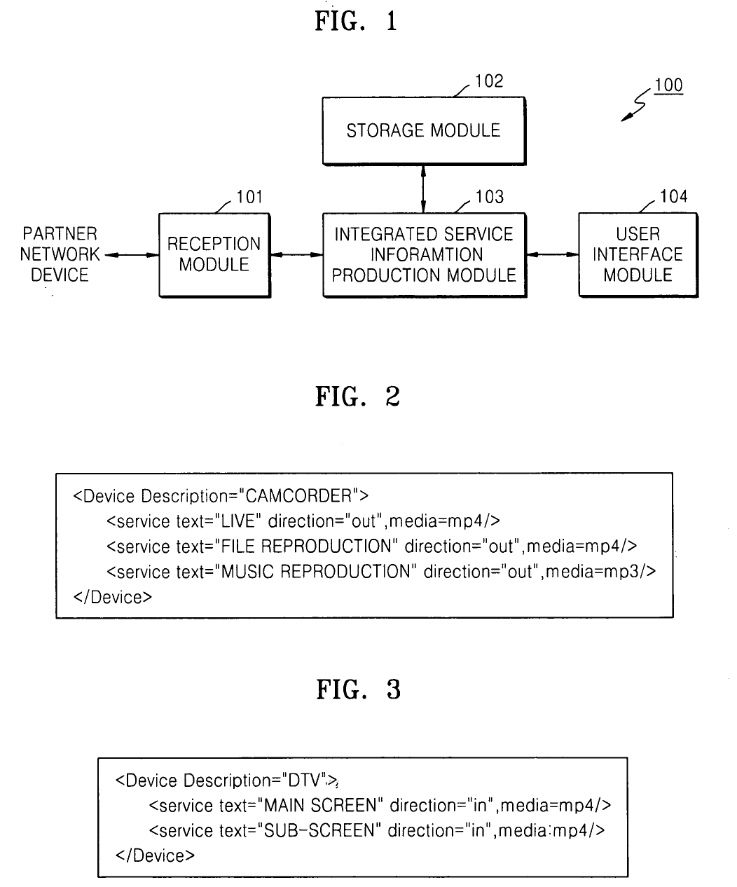

FIG. 1 is a block diagram of a network device 100 according to an exemplary embodiment of the present invention. Referring to FIG. 1, the network device 100 includes a reception module 101, a storage module 102, an integrated service information production module 103, and a user interface module 104.

The reception module 101 receives service information from a partner network device (not shown) which is connected with the network device 100. The service information about the partner network device may be a description of the partner network device. Hence, if the network device 100 is a DTV and the partner network device is a camcorder, the service information received from the partner network device may be defined as illustrated in FIG. 2. The network device 100 and the partner network device may be CE devices that are able to be networked.

The storage module 102 stores service information about the network device 100. Like the service information about the partner network device, the service information about the network device 100 may be a description of the network device 100. Hence, as in the above-described case, if the network device 100 is a DTV, the service information stored in the storage module 102 may be defined as illustrated in FIG. 3.

The integrated service information production module 103 produces integrated service information from the service information about the partner network device received by the reception module 101 and the service information about the network device 100 stored in the storage module 102.

More specifically, the integrated service information production module 103 produces the integrated service information by combining the service information about the partner network device received by the reception module 101 with the service information about the network device 100 stored in the storage module 102.

In order to combine the service information about the partner network device with the service information about the network device 100, the integrated service information production module 103 first checks transmission direction information for each service and media type information that are included in the service information about the partner network device received through the reception module 101. Then, the integrated service information production module 103 checks transmission direction information for each service and media type information that are included in the service information stored in the storage module 102, thereby determining whether information about a service of the network device 100 corresponding to the received service information exists.

More specifically, when the media type information included in the service information stored in the storage module 102 is the same as that included in the received service information and the transmission direction information included in the service information stored in the storage module 102 is opposite to that of the received service information, the integrated service information production module 103 determines that service information about the network device 100 corresponding to the received service information exists in the storage module 102.

For example, when the service information received from the partner network device is as illustrated in FIG. 2 and the service information about the network device 100 stored in the storage module 102 is as illustrated in FIG. 3, the integrated service information production module 103 first checks a transmission direction and media type of a “live” service and determines that the transmission direction of the “live” service is “out” (i.e., an output service) and the media type thereof is MP4 (i.e., MPEG 4). Then, the integrated service information production module 103 checks the service information stored in the storage module 102 and determines that “main screen” and “sub-screen” services are both “in” (i.e., input services) and the media types thereof are MP4. Consequently, the integrated service information production module 103 recognizes that “main screen” and “sub-screen” services exist as services of the network device 100 with respect to the “live” service of the partner network device. Thus, the integrated service information production module 103 produces information about an integrated service obtained by combining “main screen” and “sub-screen” services of the DTV (or the network device 100) with the “live” service of a camcorder (or the partner network device).

The integrated service information production module 103 also checks the transmission direction and media type of a service “file reproduction” and determines that the transmission direction of the “file reproduction” service is “out” (i.e., an output service) and the media type thereof is MP4. Then, the integrated service information production module 103 checks the service information stored in the storage module 102 and determines that “main screen” and “sub-screen” services are both “in” (i.e., input services) and the media types thereof are MP4. Consequently, the integrated service information production module 103 recognizes that “main screen” and “sub-screen” services exist as services of the network device 100 with respect to the “file reproduction” service of the partner network device. Hence, the integrated service information production module 103 produces information about an integrated service obtained by combining “main screen” and “sub-screen” services of the DTV (or the network device 100) with the “file reproduction” service of the camcorder (or the partner network device).

Meanwhile, as for a service “music reproduction”, it is determined that the transmission direction of the service “music reproduction” is “out” (i.e., an out service) and the media type thereof is MP3. Accordingly, the integrated service information production module 103 recognizes that no service information with respect to the “music reproduction” service exists in the service information stored in the storage module 102. This is because no services having the same media type as the media type of the “music reproduction” service are stored in the storage module 102.

Hence, the integrated service information production module 103 may not produce information about an integrated service relating to the “music reproduction” service, or produce integrated service information indicating that no services of the network device 100 exist for the service “music reproduction”, or produce integrated service information indicating that the service “music reproduction” is not available.

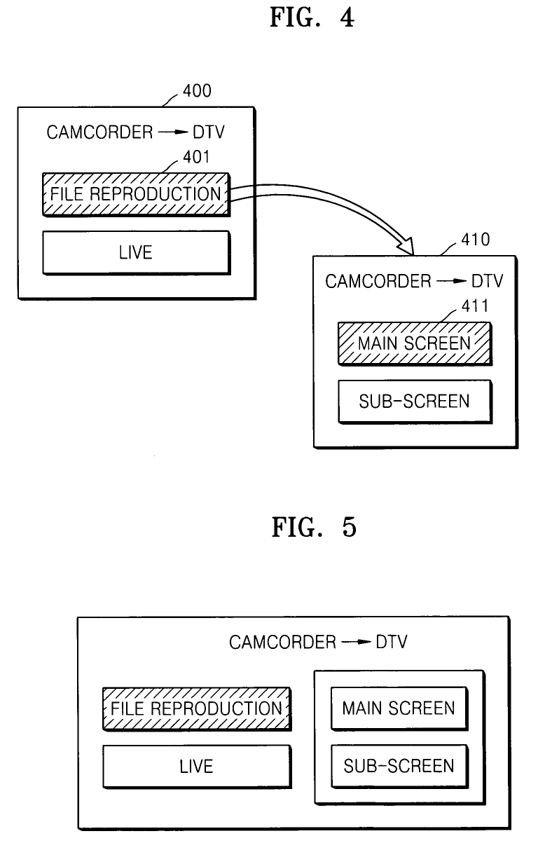

The user interface module 104 outputs the integrated service information produced by the integrated service information production module 103. When the service information received from the partner network device is as illustrated in FIG. 2 and the service information about the network device 100 stored in the storage module 102 is as illustrated in FIG. 3, the integrated service information may be as illustrated in FIG. 4. FIG. 4 illustrates an example of integrated service information produced according to the present invention, in which information about services of the camcorder is output as a top menu 400, and when one of the services is selected, information about services of the DTV corresponding to the selected service of the camcorder is output as a sub menu 410. In FIG. 4, a “file reproduction” service 401 is selected, a sub menu screen 410 corresponding to the file reproduction service 401 is output, and a “main screen” service 411 on the sub menu screen 410 is selected. When the selection as illustrated in FIG. 4 is made, a service of displaying a file reproduced by the camcorder as a main screen mode on the DTV is provided to a user.

When the network device 100 of FIG. 1 is a camcorder, the integrated service information shown in FIG. 4 is displayed on a user interface module of the camcorder. When the network device 100 of FIG. 1 is a DTV, the integrated service information shown in FIG. 4 is displayed on a user interface module of the DTV. The relationship between the top menu 400 and the submenu 410 is equally defined no matter whether the network device 100 is a camcorder or a DTV. In other words, when the network device 100 is a camcorder, the screen 400 is defined as the top menu, and the screen 410 is defined as the submenu of the service “file reproduction”. Likewise, when the network device 100 is a DTV, the screen 400 is defined as the top menu, and the screen 410 is defined as the submenu of the service “file reproduction”.

The integrated service information displayed on the user interface module 104 may be as illustrated in FIG. 5. FIG. 5 illustrates a screen on which the service information of the partner network device and the service information of the network device 100 are both displayed. When the network device 100 is a camcorder, integrated service information is output in the form of a menu as illustrated in FIG. 5. As described above with reference to FIG. 4, even when the network device 100 is a DTV, integrated service information is output in the form of a menu as illustrated in FIG. 5. A user can recognize from the menu illustrated in FIG. 5 that either a “main screen” or “sub screen” service of the DTV can be selected with respect to the “file reproduction” service of the camcorder.

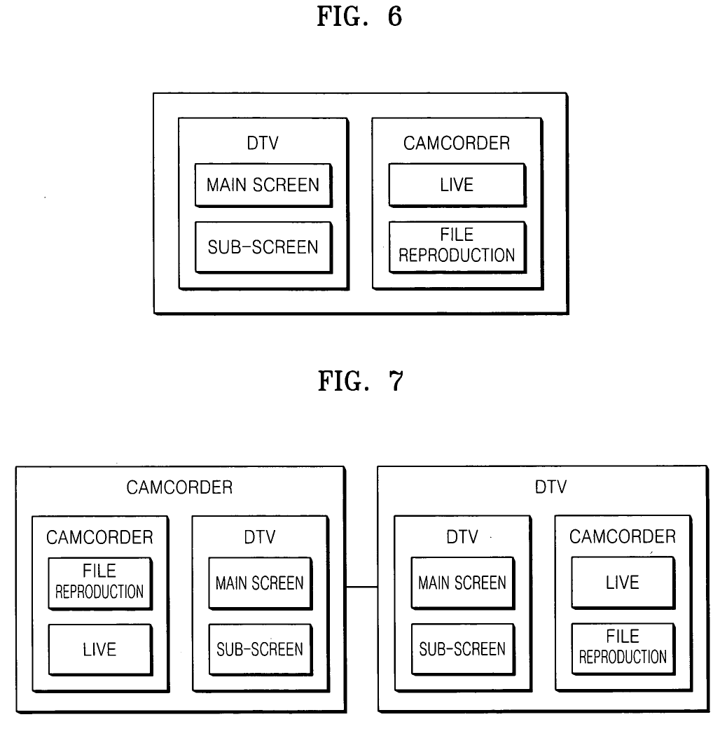

The integrated service information displayed on the user interface module 104 may be as illustrated in FIG. 6. FIG. 6 illustrates a screen on which both the service information of the partner network device and the service information of the network device 100 are displayed in such a layout that the service information of the partner network device is on the right side and the service information of the network device 100 is on the left side. Hence, it can be known from FIG. 6 that the network device 100 is a DTV.

When the integrated service information is output as illustrated in FIG. 6, integrated service information output to the partner network device is different from that output to the network device 100 in the position of service information as illustrated in FIG. 7. In FIG. 7, the camcorder displays its own service information on the left side and service information of the DTV on the right side.

The integrated service information production module 103 produces integrated service information so that the integrated service information is displayed in the form of a menu on the user interface module 104.

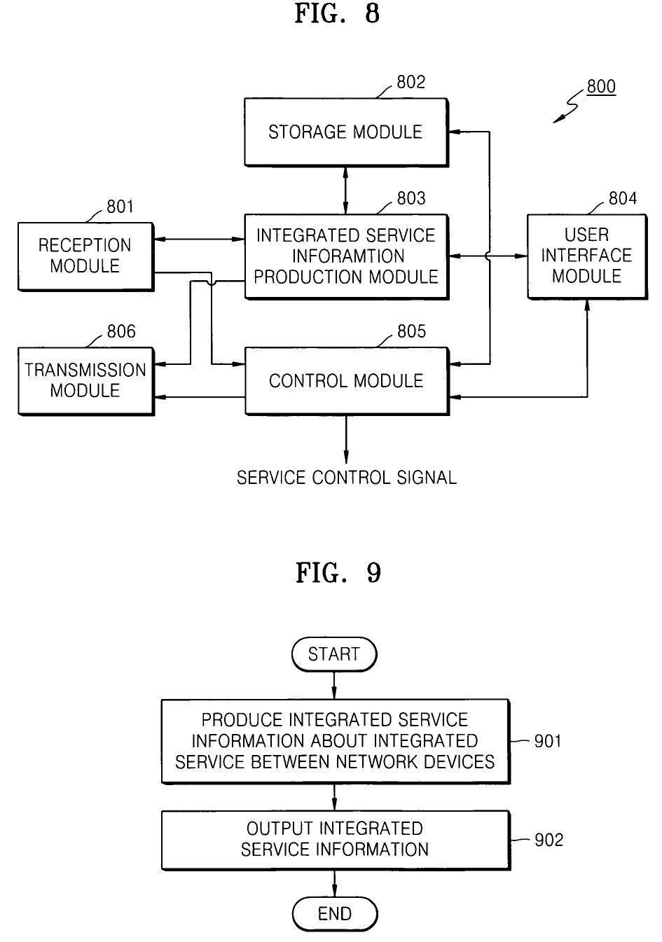

FIG. 8 is a block diagram of a network device 800 according to another exemplary embodiment of the present invention. Referring to FIG. 8, the network device 800 includes a reception module 801, a storage module 802, an integrated service information production module 803, a user interface module 804, a control module 805, and a transmission module 806.

The reception module 801, the storage module 802, and the integrated service information production module 803 have similar structures to and perform similar operations to the reception module 101, the storage module 102, and the integrated service information production module 103 of FIG. 1, respectively.

When integrated service information is displayed on the user interface module 804 through a process described above in FIG. 1, a user can input a signal for controlling the services of the network device 800 and the services of a partner network device (not shown) which is connected with the network device 800.

When the signal for controlling the services of the network device 800 and the services of a partner network device is input through the user interface module 804, the control module 805 controls a service of the network device 800 and simultaneously produces a service requesting signal for the partner network device. For example, when the network device 800 is a DTV, the partner network device is a camcorder, and a service for outputting a file (or media) reproduced from the camcorder in the form of a sub-screen is selected, the control module 805 may output a signal for controlling a sub-screen output service where the network device 800 displays the file (or media) received from the partner network device in the form of a sub-screen, and also output a service requesting signal for requesting the partner network device to perform file reproduction.

The transmission module 806 receives the service request signal from the control module 805 and transmits the same to the partner network device.

Meanwhile, when a signal for requesting information about the services of the network device 800 is received via the reception module 801, the control module 805 receives the information about the services of the network device 800 from the storage module 802 and transmits the same to the partner network device via the transmission module 806. After transmitting a service information requesting signal to the partner network device via the transmission module 806, the integrated service information production module 803 receives information about the services of the partner network device from the partner network device via the reception module 801, and produces the integrated service information using the information about the services of the partner network device.

The integrated service information production module 803 and the control module 805 may be formed into a single unit. The single unit may be defined as a control module that controls the function of the network device 800.

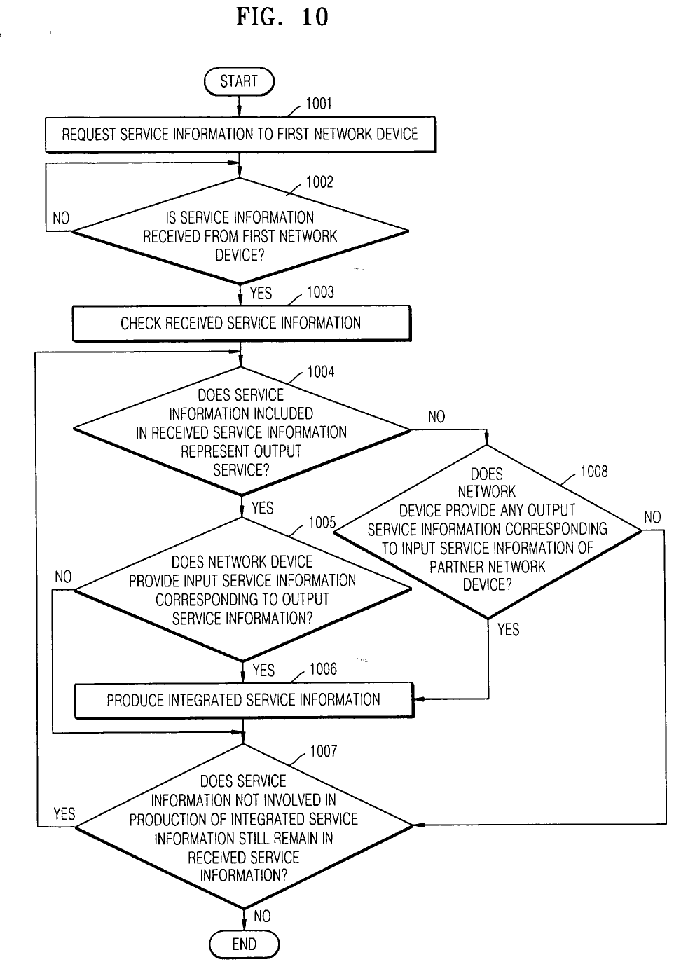

FIG. 9 is a flowchart illustrating a method of controlling a service that can be used between network devices, according to another embodiment of the present invention. Referring to FIG. 9, first, a network device produces integrated service information about an integrated service obtained by integrating a service of the network device with a service of a partner network service that is connected with the network device, in operation 901. The integrated service information may be produced according to a method as illustrated in FIG. 10. FIG. 10 is a flowchart illustrating an operation of producing integrated service information, according to an exemplary embodiment of the present invention.

Referring to FIG. 10, first, the network device requests service information from the partner network device, in operation 1001. When the service information is received from the partner network device in operation 1002, the network device checks the received service information, in operation 1003. As described above with reference to FIG. 1, the service information may be checked by checking transmission direction information and media type information of each service that are included in the service information.

When the transmission direction information of a service that is included in the received service information represents “out” (i.e., an output service) in operation 1004, the network device checks whether it provides an input service corresponding to the output service, in operation 1005. For example, when the service information about a service of the partner network device is as illustrated in FIG. 2, and information about a service of the network device is as illustrated in FIG. 3, a “live” service corresponds to the output service, and a “main screen” service and a “sub-screen” service are input services of the network device that correspond to the output service. Hence, in this case, the network device determines that it provides an input service corresponding to the output service, in operation 1005.

When it is determined that the network device provides an input service corresponding to the output service of the partner network device, the network device produces integrated service information by integrating information about the output service of the partner network device with information about the input device of the network device, in operation 1006. For example, the network device produces integrated service information by integrating information about the “live” service of the camcorder with information about the “main screen” and “sub-screen” services of the DTV.

Thereafter, the network device checks whether information about a service not involved in the production of the integrated service information still remains in the received service information, in operation 1007. If it is determined that non-integrated service information remains, the method is fed back to operation 1003 so that the network device repeats the above-described operations for the remaining service information. If integrated service information associated with the “live” service in the service information of FIG. 2 is produced, a “file reproduction” service may be the remaining service information.

When it is determined in operation 1005 that the network device does not provide any input service corresponding to the output service of the partner network device, the method is proceeds to operation 1007. However, the integrated service information producing operation may produce integrated service information provided that the network device does not provide input services corresponding to the output service of the partner network device or integrated service information provided that the output service of the partner network device is not selectable.

Meanwhile, when it is determined in operation 1004 that the transmission direction of the service does not indicate an output service (i.e., the service is an input service) it is checked whether the network device provides any output service information corresponding to the input service information of the partner network device, in operation 1008. When it is determined in operation 1008 that the network device provides output service information corresponding to the input service information of the partner network device, the method proceeds to operation 1006 so as to produce integrated service information based on the received input service and the output service information of the network device, and then proceeds to operation 1007. However, when it is determined in operation 1008 that the network device provides no output service information corresponding to the input service information of the partner network device, this means that the network device provides no output service information with respect to received input service information, and thus the method proceeds to operation 1007. Then, an integrated service information producing operation is performed with respect to the next received service information, or the method is finished. However, the integrated service information producing operation may produce integrated service information provided that the network device does not provide output service information corresponding to the received service information or integrated service information provided that the received service information is not selectable.

When it is determined in operation 1007 that no service information remains that has not undergone the integrated service information producing operation, the method is finished.

Referring back to FIG. 9, the integrated service information produced as described above is displayed to the user, in operation 902. The integrated service information may be displayed in the form of menus as illustrated in FIGS. 4 through 7.

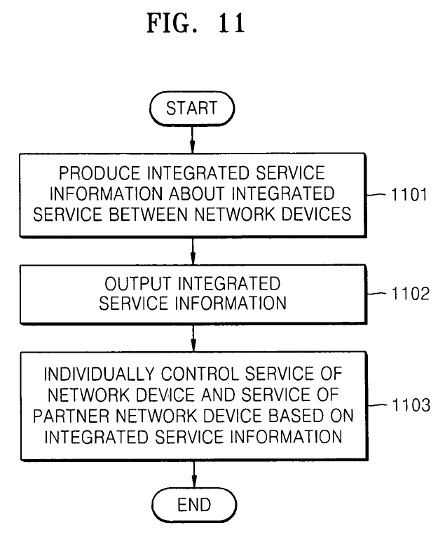

FIG. 11 is a flowchart illustrating a method of controlling a service that can be used between network devices, according to another exemplary embodiment of the present invention.

Operations 1101 and 1102 of FIG. 11 are similar to operations 901 and 902 of FIG. 9, respectively. Accordingly, when the integrated service information is produced and displayed as described above with reference to FIG. 9, the service of the network device and the service of the partner network device are individually controlled based on the integrated service information in operation 1103. The control of the services of the network device and the partner service device is performed as described above with reference to FIG. 8. In other words, a signal for controlling the service of the network device is produced, and simultaneously a service requesting signal for requesting the partner network device for a corresponding service is transmitted to the partner network device.

The methods of controlling the services that can be used between network devices illustrated in FIGS. 9 and 11 may further include an operation of transmitting the information about the service of the network device to the partner network device when the partner network device requests information about the service of the network device.

In a method of controlling services connected between network devices according to the present invention, a network device provides integrated service information obtained by integrating its own service information with the service information of a partner service device which is connected with the network device. Hence, the network device cannot only control its services but also the services of the partner network device. In other words, instead of each network device individually controlling its own services, a single network device can control both its services and the services of the partner network device. Therefore, controlling a service that can be used between network devices is facilitated.

A program for performing a method of controlling services between network devices according to the present invention can be embodied as computer readable codes on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, and floppy disks, optical data storage devices. The computer readable recording medium can also be distributed over network coupled computer systems so that the computer readable code is stored and executed in a distributed fashion. (Also, functional programs, codes, and code segments for accomplishing the present invention can be easily construed by programmers skilled in the art to which the present invention pertains.)

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling services that can be used between network devices, the method comprising:
producing integrated service information from service information of a network device and service information of a partner network device that is connected with the network device; and stet
outputting the integrated service information to the network device.

2. The method of claim 1, wherein the integrated service information is produced based on transmission direction information and media type information for each service that is included in the service information of the network device and the service information of the partner network device.

3. The method of claim 1, further comprising controlling a service of the network device and a service of the partner network device based on the integrated service information.

4. The method of claim 3, wherein the integrated service information is produced based on transmission direction information and media type information for each service that is included in the service information of the network device and the service information of the partner network device.

5. The method of claim 1, further comprising transmitting the service information of the network device to the partner network device if the partner network device requests the service information of the network device.

6. The method of claim 1, wherein the integrated service information is displayed in the form of a menu.

7. A network device comprising:
a reception module which receives service information from a partner network device which is connected to the network device;
a storage module which stores service information of the network device;
an integrated service information production module which produces integrated service information from the service information of the partner network device and the service information of the network device; and
a user interface module which outputs the integrated service information.

8. The network device of claim 7, wherein the integrated service information production module produces the integrated service information based on transmission direction information and media type for each service that is included in the service information of the network device and the service information of the partner network device.

9. The network device of claim 8, further comprising:
a control module which controls a service of the network device and simultaneously producing a service request signal for requesting the partner network device for a service, in response to a signal for controlling the services of the network device and the services of the partner network device based on the integrated service information output by the user interface module; and
a transmission module which transmits the service request signal produced by the control module the partner network device.

10. The network device of claim 7, further comprising:
a control module which controls a service of the network device and simultaneously produces a service request signal for requesting the partner network device for a service, in response to a signal for controlling services of the network device and services of the partner network device based on the integrated service information output by the user interface module; and
a transmission module which transmits the service request signal produced by the control module to the partner network device.

11. The network device of claim 9, wherein the control module further performs a function of transmitting the service information of the network device stored in the storage module to the partner network device via the transmission module.

12. The network device of claim 7, wherein the integrated service information is displayed in the form of a menu.

13. A computer-readable storage medium that stores a program for performing a method of controlling services connected between network devices, the method comprising:
producing integrated service information from service information of a network device and service information of a partner network device that is connected with the network device; and
outputting the integrated service information to the network device.

14. The computer-readable storage medium of claim 13, the method further comprising controlling a service of the network device and a service of the partner network device based on the integrated service information.

15. The method of claim 1, wherein the service information of the network device is a description of the network device and the service information of the partner network device is a description of the partner network device.

16. The method of claim 1, wherein producing integrated service information is performed by combining the service information of the network device with the service information of the partner network device.

17. The method of claim 2, wherein producing the integrated service information according to transmission direction information further includes performing a function of determining whether the network device provides an input service corresponding to an output service of the parent network device.

18. The method of claim 17, wherein producing the integrated service information according to media type information further includes performs a function of determining whether media type information included in the service information of the network device is the same as media type information included in the service information of the parent network device.

19. The network device according to claim 7, where in the service information of the network device is a description of the network device and the service information of the partner network device is a description of the partner network device.

20. The network device according to claim 7, wherein the integrated service information production module produces the integrated service information by combining the service information of the network device with the service information of the partner network device.

21. The network device according to claim 8, wherein the integrated service information production module produces the integrated service information according to transmission direction information by performing a function of determining whether the network device provides an input service corresponding to an output service of the parent network device.

22. The network device according to claim 21, wherein the integrated service information production module produces the integrated service information according to media type information by performing a function of determining whether media type information included in the service information of the network device is the same as media type information included in the service information of the parent network device.

23. The network device according to claim 7, wherein the integrated service information production module removes information about a service not involved in the production of the integrated service information.
